(19) United States
(12) Patent Application Publication
(10) Pub. No.: US 2011/0087714 A1
(43) Pub. Date: Apr. 14, 2011

(54) Methodology Based on Oracle's Umbel Data Import and Export

(75) Inventors: YI HE, Nanjing (CN); RUHUA LU, Nanjing (CN); JIANQIANG DENG, Nanjing (CN); JINSONG WANG, Nanjing (CN); ZHIGANG YU, Nanjing (CN); JIUSONG SHAO, Nanjing (CN)

(73) Assignee: LINKAGE TECHNOLOGY GROUP CO., LTD., Nanjing (CN)

(21) Appl. No.: 12/901,833

(22) Filed: Oct. 11, 2010

(30) Foreign Application Priority Data
Oct. 12, 2009 (CN) 200910036263.7

(51) Int. Cl. G06F 17/30

(52) U.S. Cl. 707/822; 707/E17.005

(57) ABSTRACT

Based on the ORACLE's umbel data import and export method,

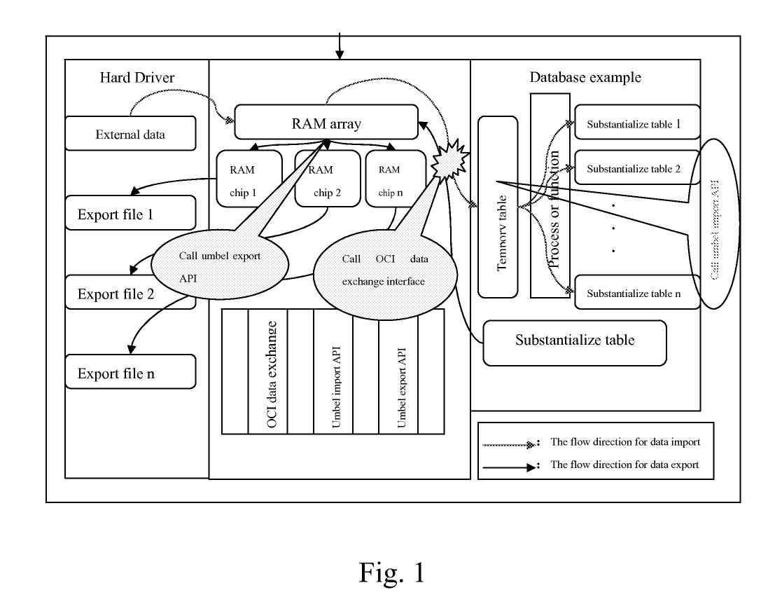

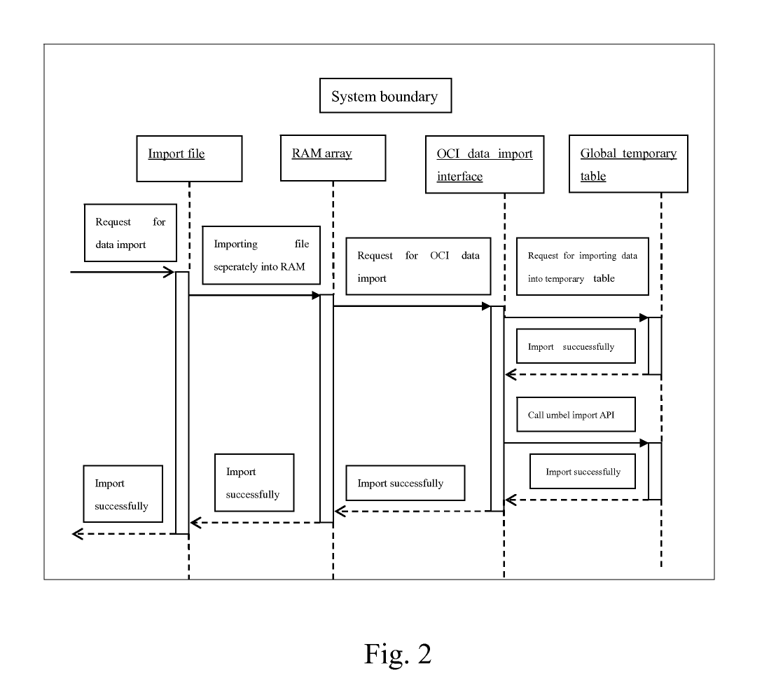

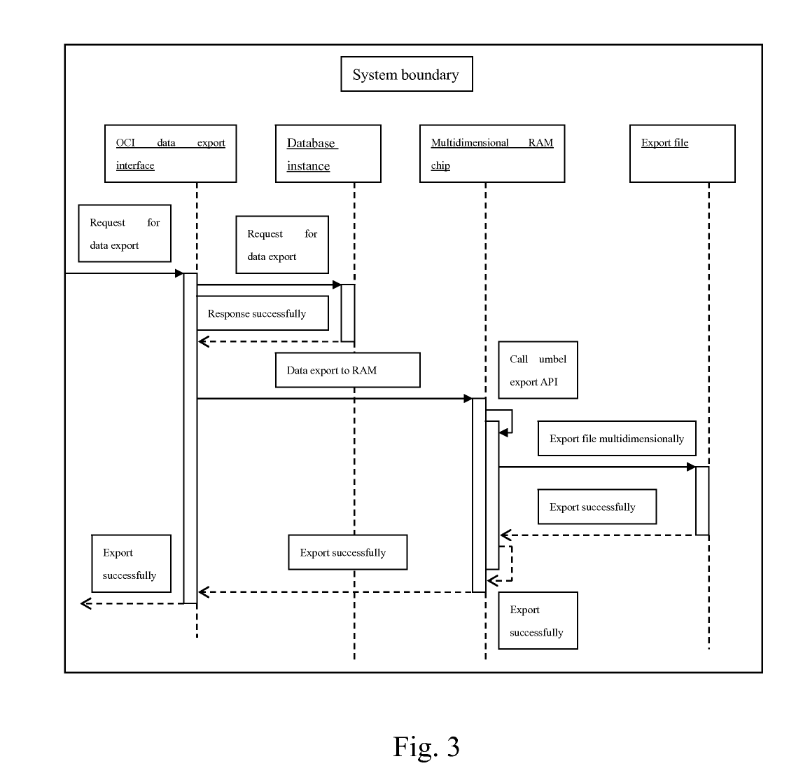

1) data was imported, a main process would pack the external data into a memory array and then reading the external data into a RAM; packed exchange interface of the OCI data will be resolved by the RAM array, and import the array to a global temporary table; dispersion of data and multidimensional statistical data totally depend on the reference of API which provides better freedom and flexibility; 2) export an internal data package: the umbel import and export API is based on the global temporary table's umbel import API (the interface of application) and the multi-dimensional memory chip's umbel export API.

### CROSS REFERENCE TO RELATED PATENT APPLICATION

This application claims the Chinese patent application No. 200910036263.7 filed on Oct. 12, 2009, which application is incorporated herein by reference.

### FIELD OF THE INVENTION

This invention is related to the data import and export technology of Oracle, in particular with the umbel data import and export method which is exports single point data to multi-point/single point.

### BACKGROUND OF THE INVENTION

There are currently two types of data import and export technology. The first one is data backup and recovery; and the second one is using the external data import to the database or using internal data export to the database. This invention belongs to the second type which is using the external data import to the database or using internal data export to the database. The second type of data import and export technology has SQL* Loader, Spool and etc. Most of these tools and methods worked on the cost of import and export, and the implementation efficiency of bulk information, but these tools currently only support the import and export of the origin data. They support neither the decentralized data import and export operations, nor the programmable data import and export interfaces.

### SUMMARY OF THE INVENTION

The purpose of the invention is to provide an umbel import and export methodology that is based on the global temporary table and multidimensional RAM chips. The invention aims at providing a solution for existing data import and export tools which cannot export single point data to multi-point/single point.

The technical solution of this invention is based on the ORACLE's umbel data import and export method. When the data was imported, the main process would pack the external data into the RAM array and then reading it into RAM. After that, the packed exchange interface of the OCI data will be resolved by the RAM array, and import the array to the global temporary table; after external data was imported to the global temporary table, it would import the API by the global temporary table, which would execute the auto-defined ORACLE function or process as functional parameter. Then, it will distribute external data to the customized multiple substantilize table, the customized ORACLE function or process would define extent of distribution of the global temporary table. Dispersion of the data and multidimensional statistical data totally depend on the actual parameter of API which provides better freedom and flexibility.

Export the internal data package: When export the temporary packaged OCI, the data exchange interface would save into the RAM as the RAM array and export the RAM array in group; after that, the system would use the multidimensional RAM chips to umbel export API, and the API would execute the auto-defined ORACLE function or process as functional parameter, and spread the internal data to multiple destinations. Again, the dispersion of the data and multidimensional statistical data totally depend on the actual parameter of API which provides better freedom and flexibility. The umbel import and export API is based on the global temporary table's umbel import API (Application Programming Interface) and the multidimensional RAM chip's umbel export API.

The invention adopt the method that is based on OCI's programmable interface package: by using the OCI programmable interface, it could package the complicated API all together and complete the analysis of RAM array and SQL, SQL execution, data import, data export, regression, submission and etc. Complete the liner import and export through these micro operational data controls.

The composition of the invention based on the following components:

1) Based on OCI's data exchange interface, OCI is ORACLE Call Interface which is also known as data exchange interface. It provides a set of interfacing sub-programs that could access the ORACLE database (function).

2) Based on the global temporary table's umbel import API (Application Programming Interface);

3) Based on multidimensional RAM chip's umbel export API. The benefits of this invention: 1) by using component of the OCI packaged data exchange interface, it could reduce the times of SQL's analysis and execution which largely increases the efficiency of data import and export. SQL is structured query language as well as a database query and programming language. 2) By using the global temporary table and open-sourced umbel import API could import data through multidimensional approach to spread them into every substantialize table of database. 3) By using RAM array and open-sourced umbel export API, it can export data through multidimensional approach to distribute to multiple files.

The advantage of this invention comparing with the existing method of import and export: The existing method of import and export can only import the external data to the single database or exporting the data to the external point which cannot proceed the multidimensional import and export that meets the data's specific requirement. The invention can let data make the multidimensional distribution of import and export and also support complex data middle layer or multi-channel data output.

### BRIEF DESCRIPTION OF THE DRAWINGS

Diagram 1 shows the structure of this invention.

Diagram 2 is the data import sequencing invention.

Diagram 3 is the data export sequencing of this invention.

### DETAIL DESCRIPTION OF THE INVENTION

Programmable umbel import API: the process would calling the packaged OCI data exchange interface and import the external data to the global temporary table and then the process would call the umbel import API. The API would execute the auto-defined ORACLE function or process as parameter to analysis temporary table's data. Then, it will distribute the temporary table's data to multiple substantilize table by using multidimensional method. Dispersion of the data and multidimensional statistical data totally depend on the actual parameter of API which provides better freedom and flexibility.

Programmable umbel import API: the process would calling the packaged OCI data exchange interface and export the internal data to the RAM array, and then the process would call the umbel export API. The API would execute the auto-defined function as parameter, and export RAM array's data separately to multiple files. Again, the dispersion of the data and multidimensional statistical data totally depend on the actuarial parameter of API which provides better freedom and flexibility.
(1) Data Import Process

1. The Process would process the external data into the RAM array;

2. After calling the packaged OCI data exchange interface, it would analysis the RAM array in group and execute the SQL in group and import into the global temporary table;

3. When the process calls umbel import API, API would consider the auto-defined ORACLE process or function as the actual parameter to analysis the global temporary table and then spread the data into a number of substantialize tables;

4. The process will submit and clean up RAM arrays. ORACLE would automatically clean up temporary table and submit every substantialize table, and then release system resources.
(2) Data Export Process

1. The process would call the packaged OCI data exchange interface and exports the internal data to the RAM array;

2. Calling umbel export API, the API would execute by following the auto-defined function indicator as the actual parameter of API, automatically define the RAM's array, and export to a number of files by adopting the multidimensional methods;

1. If the system did not provide the auto-defined function indicator as the actual parameter of API, it would export the data file as its original structure.

2. The process will submit and clean up RAM array, and then release system resources.

What is claimed is:

1. Based on the ORACLE's umbel data import and export method, comprising:
1) when external data was imported (Program) , a main process would pack the external data into a memory array and then reading the external data into a RAM;
after that, packed exchange interface of the OCI data will be resolved by the RAM array, and import the array to a global temporary table;
after the external data was imported to the global temporary table, it would import the API by the global temporary table, which would execute auto-defined ORACLE function or process as functional parameter;
then, it will distribute the external data to customized multiple entities in the table, customized ORACLE function or process would define extent of distribution of the global temporary table;
dispersion of data and multidimensional statistical data totally depend on the reference of API which provides better freedom and flexibility;
2) export an internal data package:
when export a temporary packaged OCI, a data exchange interface would save into the RAM as a RAM array and export the RAM array in group;
after that, the system would use multidimensional memory chips to umbel export API, and the API would execute auto-defined ORACLE function or process as functional parameter, and spread the internal data to multiple destinations;
again, the dispersion of the data and multidimensional statistical data totally depend on reference of API which provides better freedom and flexibility;
the umbel import and export API is based on the global temporary table's umbel import API (the interface of application) and the multi-dimensional memory chip's umbel export API.

2. A method based on OCI's programmable interface package comprising:
by using OCI programmable interface, it could package complicated API all together and complete analysis of RAM array and SQL, SQL execution, data import, data export, regression, submission and etc.;
complete a liner import and export through these micro operational data controls.
